(19) United States
(12) Patent Application Publication
(10) Pub. No.: US 2015/0135137 A1
(43) Pub. Date: May 14, 2015

(54) User Experience for Processing and Cropping Images

(71) Applicant: Microsoft Corporation, Redmond, WA (US)

(72) Inventors: Nobuko Miwa, Tokyo (JP); Junko Kyomasu, Tokyo (JP); Hirokazu Sawada, Tokyo (JP); Sze Vin Julius Ang, Tokyo (JP); Koji Watanabe, Tokyo (JP); Dan Ito, Tokyo (JP); Tsutomu Yanagida, Kawasaki-shi (JP); Enrique Moreno Daniel, Tokyo (JP); Tsutomu Kagoshima, Tokyo (JP)

(73) Assignee: Microsoft Corporation, Redmond, WA (US)

(21) Appl. No.: 14/077,926

(22) Filed: Nov. 12, 2013

(51) Int. Cl. G06F 3/0482; G06F 3/0488; G06T 7/00; G06F 3/0484

(52) U.S. Cl. CPC G06F 3/0482; G06F 3/04842; G06F 3/04883; G06T 7/0081; G06T 2207/10004; G06T 2210/22; G06T 2200/24
USPC 715/808

(57) ABSTRACT

A user experience for processing and cropping images is provided. A menu of image processing modes may be displayed by a computing device. A selection of one of the image processing modes from the menu may then be received. An image may then be received by the computing device. The computing device may then process the received image based on the selected image processing mode. The computing device may then display user controls overlaying the processed image. A selection of one or more of the user controls may then be received to re-frame one or more boundaries of the processed image. The computing device may then send the processed and re-framed image to a productivity application.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND

Mobile computing devices, such as smartphones and tablets, are increasingly being utilized in lieu of standalone cameras for capturing photographs of whiteboards, blackboards (i.e., a writing surface having a colored background) and documents in association with various productivity scenarios in the workplace (e.g., meetings comprising slide presentations, brainstorming sessions and the like). The captured photographic images may then be utilized in one or more productivity applications for generating electronic documents. The aforementioned capturing of photographic images however, suffers from a number of drawbacks. For example, many photographs must be taken at an angle (which may be due to the physical dimension limitations of the room in which a user is located) as well as in less than ideal lighting conditions (e.g., due to glare from incident lights in a meeting room). As a result, captured photographic images often contain unwanted perspective skews as well as unwanted regions (e.g., walls outside a whiteboard frame or table surfaces outside a document page boundary) which must be rectified prior to utilizing the images in other applications (e.g., productivity application software). It is with respect to these considerations and others that the various embodiments of the present invention have been made.

### SUMMARY

This summary is provided to introduce a selection of concepts in a simplified form that are further described below in the Detailed Description. This summary is not intended to identify key features or essential features of the claimed subject matter, nor is it intended as an aid in determining the scope of the claimed subject matter.

Embodiments provide a user experience for processing and cropping images. A menu of image processing modes may be displayed by a computing device. A selection of one of the image processing modes from the menu may then be received. An image may then be received by the computing device. The computing device may then process the received image based on the selected image processing mode. The computing device may then display user controls overlaying the processed image. A selection of one or more of the user controls may then be received to re-frame one or more boundaries of the processed image. The computing device may then send the processed and re-framed image to a productivity application.

These and other features and advantages will be apparent from a reading of the following detailed description and a review of the associated drawings. It is to be understood that both the foregoing general description and the following detailed description are illustrative only and are not restrictive of the invention as claimed.

### BRIEF DESCRIPTION OF THE DRAWINGS

FIG. 1 shows a screen display of a computing device which includes a user interface for retrieving an image for processing, in accordance with an embodiment;

FIG. 2 shows a screen display of a computing device which includes a user interface for selecting an image processing mode prior to receiving an image, in accordance with an embodiment;

FIG. 3 shows a screen display of the computing device which displays an image library for selecting an image for processing, in accordance with an embodiment;

FIG. 4 shows a screen display of a computing device which includes a user interface for selecting an image processing mode and for selecting a cropping mode, after receiving an image, in accordance with an embodiment;

FIG. 5 shows a screen display of a computing device which includes user controls for cropping a processed whiteboard image, in accordance with an embodiment;

FIG. 6 shows a screen display of a computing device which includes user controls for cropping a processed document image, in accordance with an embodiment;

FIG. 7 shows a screen display of a computing device which includes a user interface for selecting an image processing mode for receiving multiple images, in accordance with an embodiment;

FIG. 8 is a block diagram illustrating a computing system architecture for providing a user experience for processing and cropping images, in accordance with an embodiment;

FIG. 9 is a flow diagram illustrating a routine for processing and cropping images, in accordance with an embodiment;

FIG. 10 is a simplified block diagram of a computing device with which various embodiments may be practiced;

FIG. 11A is a simplified block diagram of a mobile computing device with which various embodiments may be practiced;

FIG. 11B is a simplified block diagram of a mobile computing device with which various embodiments may be practiced; and

FIG. 12 is a simplified block diagram of a distributed computing system in which various embodiments may be practiced.

### DETAILED DESCRIPTION

Embodiments provide a user experience for processing and cropping images. A menu of image processing modes may be displayed by a computing device. A selection of one of the image processing modes from the menu may then be received. An image may then be received by the computing device. The computing device may then process the received image based on the selected image processing mode. The computing device may then display user controls overlaying the processed image. A selection of one or more of the user controls may then be received to re-frame one or more boundaries of the processed image. The computing device may then send the processed and re-framed image to a productivity application.

In the following detailed description, references are made to the accompanying drawings that form a part hereof, and in which are shown by way of illustrations specific embodiments or examples. These embodiments may be combined, other embodiments may be utilized, and structural changes may be made without departing from the spirit or scope of the present invention. The following detailed description is therefore not to be taken in a limiting sense, and the scope of the present invention is defined by the appended claims and their equivalents.

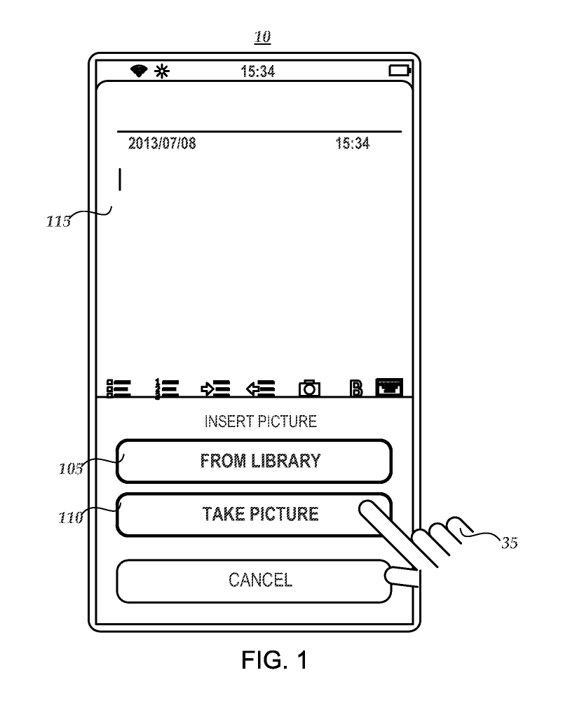

Referring now to the drawings, in which like numerals represent like elements through the several figures, various aspects of the present invention will be described. FIG. 1 shows a screen display of a computing device 10 which includes a user interface for retrieving an image for processing, in accordance with an embodiment. The user interface may include user controls 105 and 110 which may be selected by a user (represented by the hand 35) to insert an image into an area 115 of the screen display on the computing device 10. In particular, the user control 105 may be selected to retrieve an image from an image library (which may be stored in the computing device 10 or on in an external storage) and the user control 110 may be selected to capture a photograph using an image capture device (e.g., a still or video camera). In accordance with various embodiments, the selection of the user controls 105 and 110 may be made by any number of gestures including tapping and swiping gestures. It should be understood, that in accordance with alternative embodiments, the selection of the user controls 105 and 110 may also be made via an input device (e.g., a keyboard, mouse, touchpad, etc.) which may be integrated in or in communication with, the computing device 10. In accordance with various embodiments, the computing device 10 may comprise a mobile computing device (such as smartphone or tablet computer), a laptop computing device or a desktop computing device.

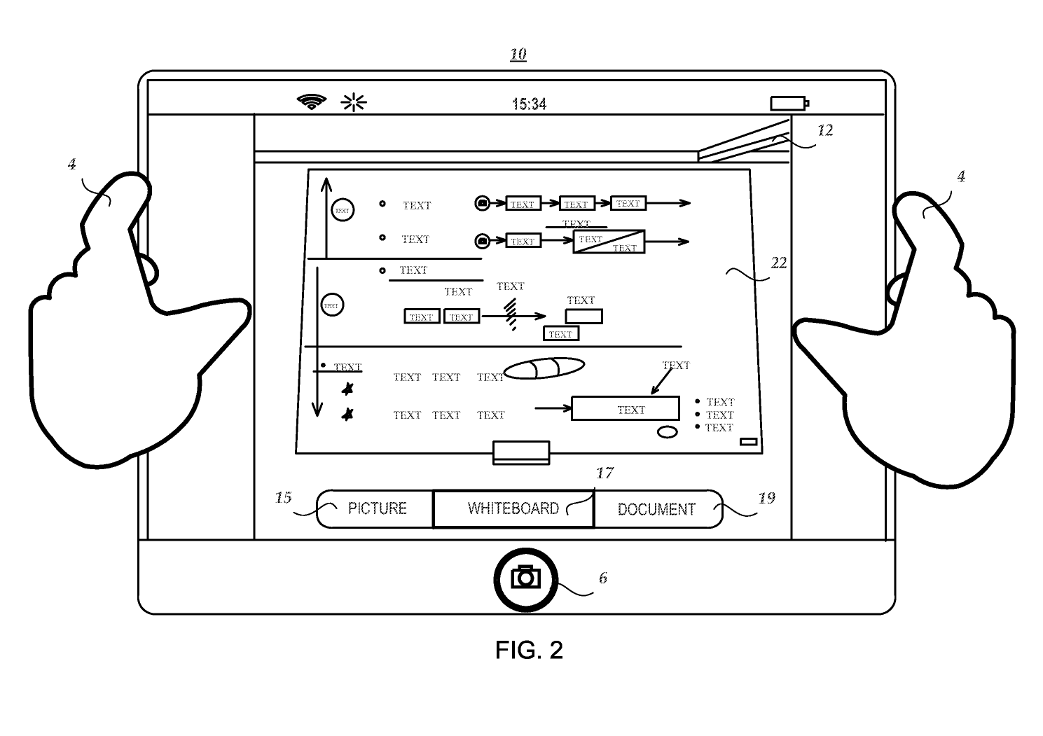

FIG. 2 shows a screen display of the computing device 10 which includes a user interface for selecting an image processing mode prior to receiving an image, in accordance with an embodiment. The user interface may include user controls 15, 17 and 19. User control 15 may be utilized to select an image processing mode configured for standard photographic images, user control 17 may be utilized to select an image processing mode configured for whiteboard images and user control 19 may be utilized to select an image processing mode configured for document images. In accordance with various embodiments, the selection of the user controls 15, 17 and 19 may be made by any number of gestures including tapping and swiping gestures. As shown in FIG. 2, the user control 17 has been selected for whiteboard image processing and a user (represented by hands 4) is preparing to capture an image of whiteboard 22 which may be, for example, mounted on the wall of a meeting room having a ceiling 2. The user may then capture the image of the whiteboard 22 using image capture button 6.

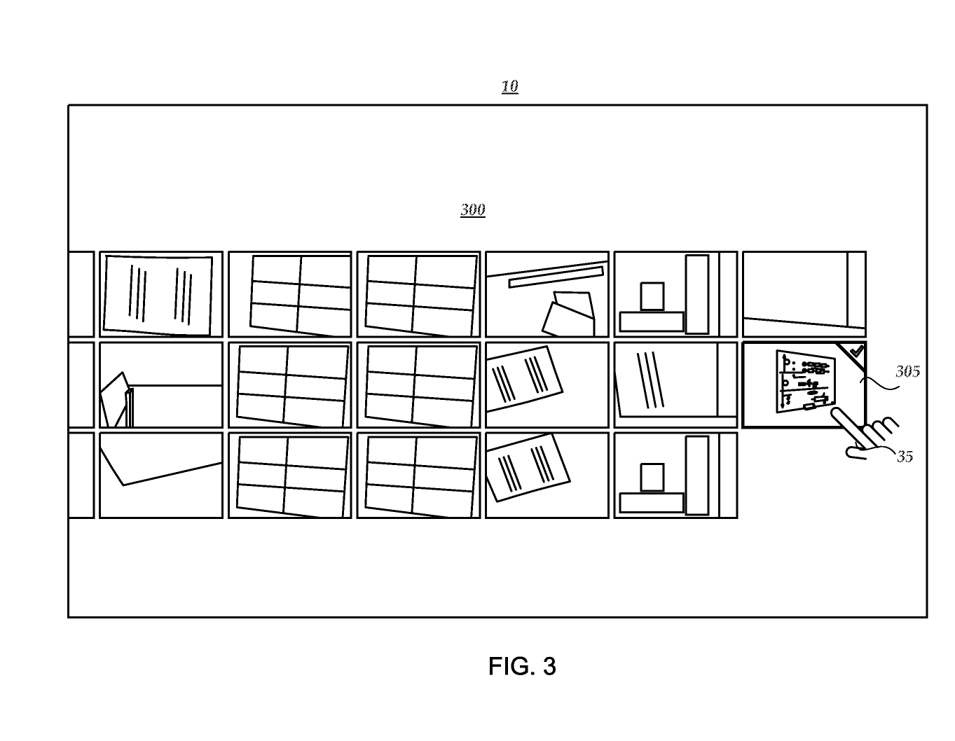

FIG. 3 shows a screen display of the computing device 10 which displays an image library 300 for selecting an image for processing, in accordance with an embodiment. The image library 300 may comprise standard photographic images, document images and whiteboard images which are stored on the computing device 10 or in an external storage (and accessed by the computing device 10 over a network). As shown in FIG. 3, a user (represented by the hand 35) may select whiteboard image 305 from the library 300 for image processing.

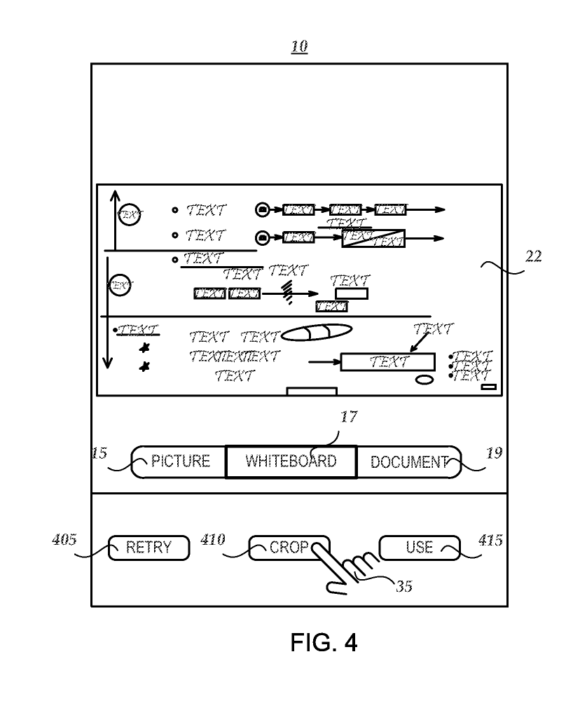

FIG. 4 shows a screen display of the computing device 10 which includes a user interface for selecting an image processing mode and for selecting a cropping mode, after receiving an image, in accordance with an embodiment. The screen display includes a processed image of the whiteboard 22 following image capture (i.e., either via taking a photograph or retrieval from an image library). It should be understood that the image processing applied to the whiteboard 22 may be performed automatically by a productivity application executing on the computing device 10. In accordance with an embodiment, the aforementioned productivity application may be configured to execute one or more image processing and cropping algorithms to enhance the quality of whiteboard and document images (e.g., providing color balance and removing background noise, stains and glare that may be present in a raw image) and attempt to correct any skew that may be present. Illustrative image processing and cropping algorithms are described in U.S. patent application Ser. No. ______ (Attorney Docket Number 14917.2398U.S. Ser. No. 01/340,149.01) entitled “Image Processing for Productivity Applications,” and which is incorporated herein, by reference.

The user interface may include the user controls 15, 17 and 19 (discussed above with respect to FIG. 2) for selecting standard photographic, whiteboard and document image processing modes, respectively. The user interface may also include the user controls 305, 310 and 315 which may be selected by the user 35 for recapturing a processed image (i.e., “retry”), cropping a processed image or, if the user 35 is satisfied with the automatic image processing and cropping, using the image in one or more productivity applications, respectively.

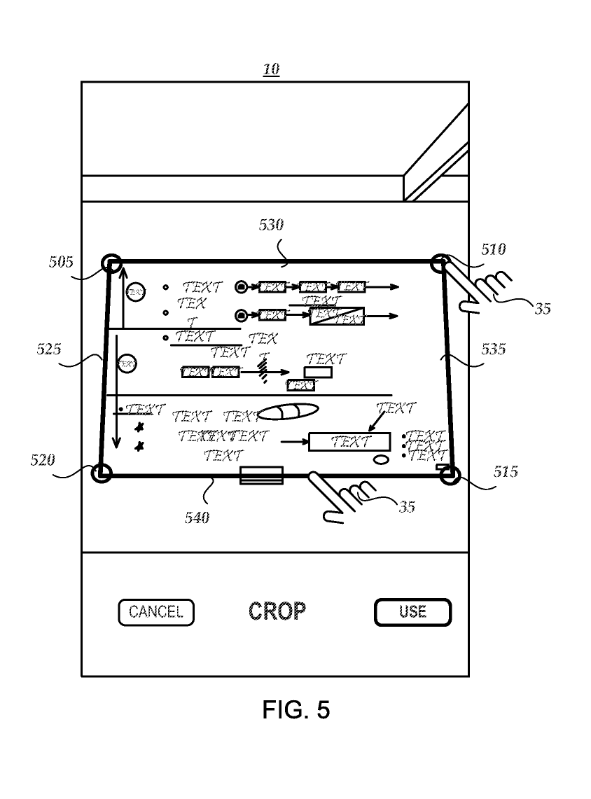

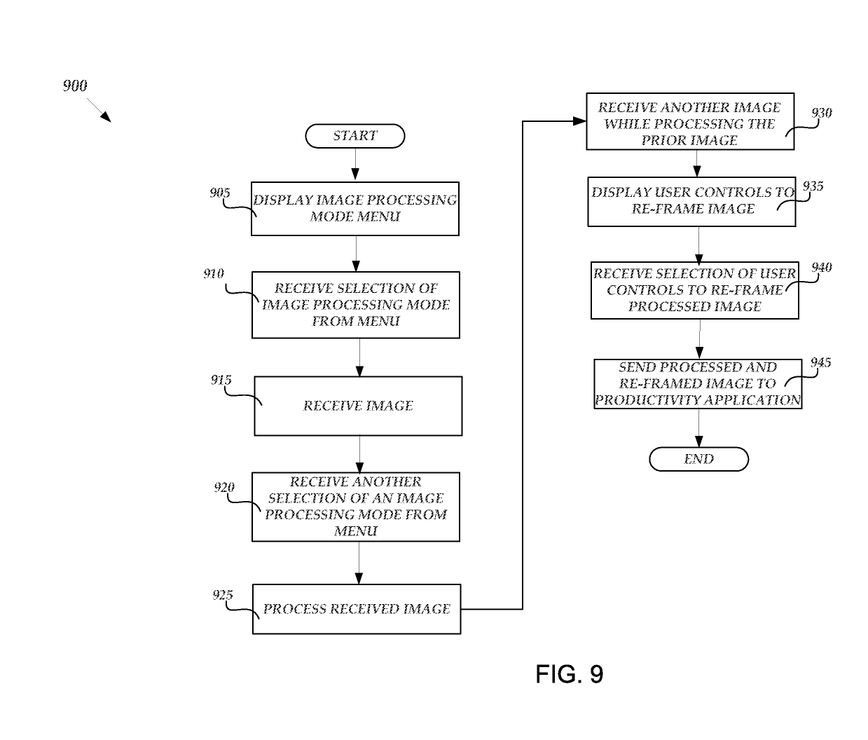

FIG. 5 shows a screen display of the computing device 10 which includes user controls for cropping a processed whiteboard image, in accordance with an embodiment. The user controls may comprise edge controls 505, 510, 515 and 520 as well as border controls 525, 530, 535 and 540 which represent corners and edges of a whiteboard image previously detected during image processing and which are shown as a quadrangle surrounding the image (i.e., a crop zone). As will be described in greater detail below with respect to FIG. 9, the edge controls 505-520 and the border controls 525-540 may be selected by the user 35 (i.e., by tapping and dragging) to adjust the crop zone.

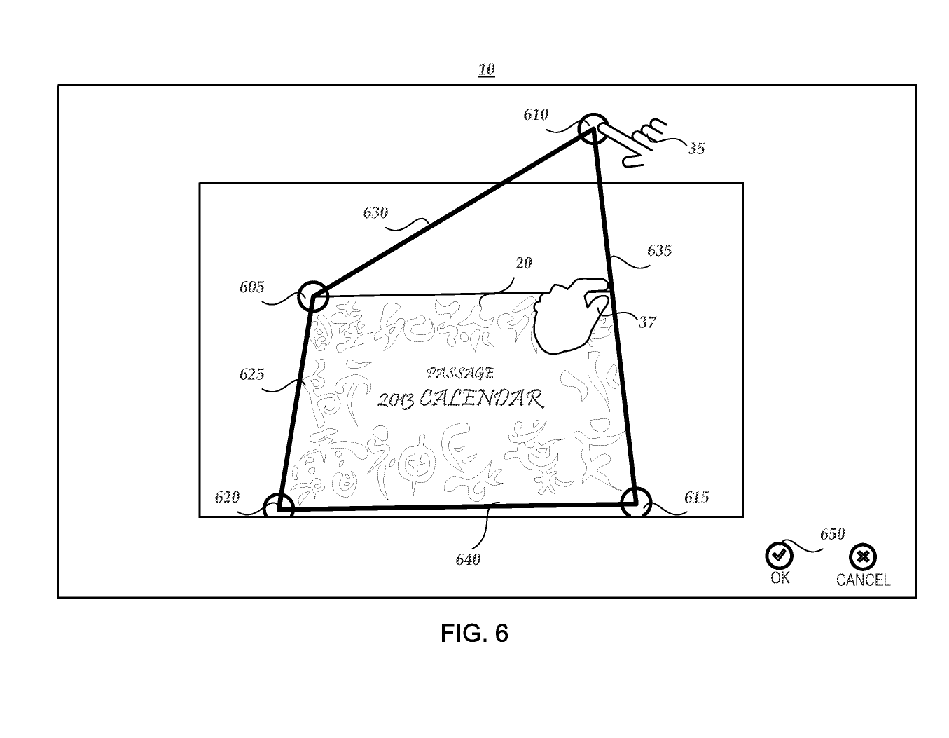

FIG. 6 shows a screen display of the computing device 10 which includes user controls for cropping a processed image of a document 20, in accordance with an embodiment. The user controls may comprise edge controls 605, 610, 615 and 620 as well as border controls 625, 630, 635 and 640 which represent corners and edges of a document image previously detected during image processing and which are shown as a quadrangle surrounding the image (i.e., a crop zone). As shown in FIG. 6, the user 35 is in the process of adjusting the crop zone by tapping and dragging the edge control 610 upward resulting in the borders. It should be understood that a user (e.g., user 37) may also by use pinch-in/pinch-out gestures to move out the corners of the document image so as to place the quadrangle in a desired location. The user 37 may also use pinch-in/pinch-out gestures to zoom in or out of the document image. The cropping of processed images for documents will be described in greater detail below with respect to FIG. 9.

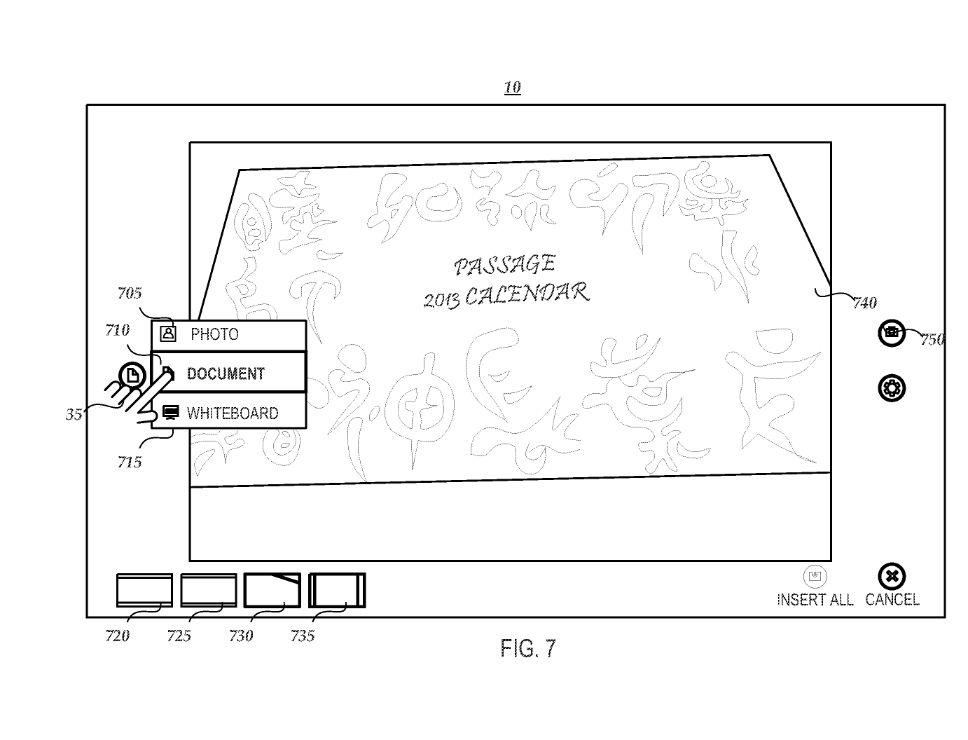

FIG. 7 shows a screen display of the computing device 10 which includes a user interface for selecting an image processing mode for receiving multiple images, in accordance with an embodiment. The user interface may include user controls 705, 710 and 715. User control 705 may be utilized to select an image processing mode configured for standard photographic images, user control 710 may be utilized to select an image processing mode configured for document images and user control 715 may be utilized to select an image processing mode configured for whiteboard images. In accordance with various embodiments, the selection of the user controls 705, 710 and 715 may be made by any number of gestures including tapping and swiping gestures. As shown in FIG. 7, the user control 710 is being selected by the user 35 for image capture and processing of a document 740 which may be, for example, a calendar lying on a desk in an office. The user 35 may capture the image of the document 740 using image capture button 750.

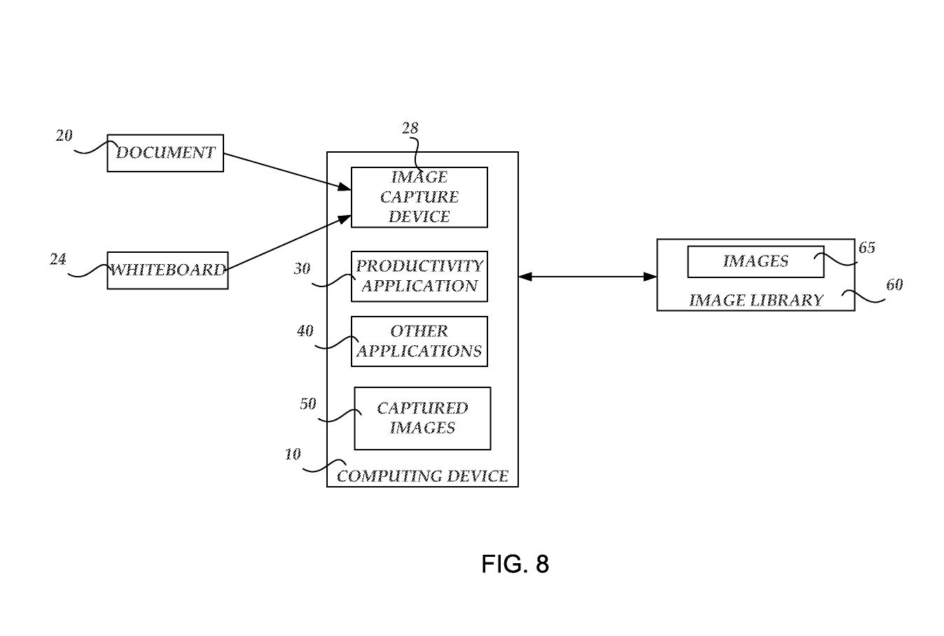

FIG. 8 is a block diagram illustrating a computing system architecture for providing a user experience for processing and cropping images, in accordance with an embodiment. The computing system architecture includes a computing device 10 which may be in communication with an image library 60. The computing device 10 may comprise an image capture device 28 (e.g., a camera or web cam), productivity application 30, other applications 40 and captured images 50. The productivity application 30 may be configured to utilize the image capture device 28 for capturing photographs or video of document 20 or whiteboard 24 and to further store the photographs or video as the captured images 50 for immediate image processing or for later retrieval and image processing (e.g., the images 65 stored in the image library 60). It should be understood that the image library 60 may be stored in the computing device or externally (e.g., in an external storage device).

In accordance with an embodiment, the document 20 may comprise a physical document (e.g., paper) containing information discussed during a meeting or presentation in an office, meeting room, school classroom or other work environment. The whiteboard 24 may comprise a physical markerboard, dry-erase board, dry-wipe board or pen-board utilized for recording notes, sketches, etc. during a meeting or presentation in an office, meeting room, school classroom or other work environment.

As will be described in greater detail below, the productivity application 30, in accordance with an embodiment, may comprise a free-form information gathering and multi-user collaboration application program configured for capturing notes (handwritten or typed) and drawings from the document 20 and/or the whiteboard 24 as images, and which is further configured for processing the images so that they may be utilized by the productivity application 30 and/or the other applications 40. In accordance with an embodiment, the productivity application 30 may comprise the ONENOTE note-taking software from MICROSOFT CORPORATION of Redmond Wash. It should be understood, however, that other productivity applications (including those from other manufacturers) may alternatively be utilized in accordance with the various embodiments described herein. It should be understood that the other applications 40 may include additional productivity application software which may receive the processed images from the productivity application 30. For example, the other applications 40 may include, without limitation, word processing software, presentation graphics software, spreadsheet software, diagramming software, project management software, publishing software and personal information management software. It should be appreciated that the aforementioned software applications may comprise individual application programs or alternatively, may be incorporated into a suite of applications such as the OFFICE application program suite from MICROSOFT CORPORATION of Redmond, Wash.

FIG. 9 is a flow diagram illustrating a routine 900 for processing and cropping images, in accordance with an embodiment. When reading the discussion of the routines presented herein, it should be appreciated that the logical operations of various embodiments of the present invention are implemented (1) as a sequence of computer implemented acts or program modules running on a computing system and/or (2) as interconnected machine logical circuits or circuit modules within the computing system. The implementation is a matter of choice dependent on the performance requirements of the computing system implementing the invention. Accordingly, the logical operations illustrated in FIG. 9 and making up the various embodiments described herein are referred to variously as operations, structural devices, acts or modules. It will be recognized by one skilled in the art that these operations, structural devices, acts and modules may be implemented in software, in hardware, in firmware, in special purpose digital logic, and any combination thereof without deviating from the spirit and scope of the present invention as recited within the claims set forth herein.

The routine 900 begins at operation 905, where the productivity application 30 executing on the computing device 10, may display an image processing mode menu to a user. For example, the image processing mode menu may include options for selecting a whiteboard processing mode (i.e., for whiteboard images) and a document processing mode (i.e., for document images).

From operation 905, the routine 900 continues to operation 910, where the productivity application 30 executing on the computing device 10, may receive a selection of an image processing mode from the menu. For example, the menu may comprise graphical user interface buttons from which a user may select either a whiteboard processing mode or a document processing mode by making either a tap gesture or a swipe gesture to select the desired mode. It should be understood that, in one embodiment, if a user selects the whiteboard processing mode for a non-whiteboard image (e.g., a blackboard object), the productivity application 30 may be configured to automatically classify the image as a blackboard object and utilize the document image processing mode thereon.

From operation 910, the routine 900 continues to operation 915, where the productivity application 30 executing on the computing device 10, may receive an image to be processed. For example, the productivity application 30 may receive an image captured by a user via an image capture device (e.g., a camera) or retrieved from an image library.

From operation 915, the routine 900 continues to operation 920, where the productivity application 30 executing on the computing device 10, may receive another selection of an image processing mode from the menu displayed at operation 905. In particular, it should be understood that in some embodiments, a user may select image processing modes both before and after capturing images.

From operation 920, the routine 900 continues to operation 925, where the productivity application 30 executing on the computing device 10, may process the image received at operation 915. In particular, the productivity application 30 may be configured to execute one or more image processing and cropping algorithms to enhance the quality of whiteboard and document images (e.g., providing color balance and removing background noise, stains and glare that may be present in a raw image) and attempt to correct any skew that may be present.

From operation 925, the routine 900 continues to operation 930, where the productivity application 30 executing on the computing device 10, may receive another image while processing the previous image received at operation 915. In particular, it should be understood that in some embodiments, the productivity application 30 may be configured to allow a user to receive and process multiple images simultaneously (i.e., the productivity application 30 may receive a new image while a previously received image is being processed).

From operation 930, the routine 900 continues to operation 935, where the productivity application 30 executing on the computing device 10, may display user controls which may be selected by a user to re-frame a received image (e.g., the image which was processed at operation 925). For example, as discussed above with respect to FIGS. 5 and 6, the productivity application 30 may be configured to display edge and border controls which a user may select to re-frame or crop the sides of a quadrangle (e.g., by tapping and dragging) which frames the processed image. It should be understood that the productivity application 30 may generate a “crop view” to provide an opportunity for a user to re-frame an image when an automatic cropping operation, applied during the prior processing of the image at operation 925, is determined to be ineffective (e.g., there is still skew present in the processed image).

From operation 935, the routine 900 continues to operation 940, where the productivity application 30 executing on the computing device 10, may receive a selection of the user controls displayed at operation 935 to re-frame a processed image. In particular, a user may re-frame one or more boundaries of the processed image selecting border and/or edge controls to crop the sides of a quadrangle framing the processed image. In one embodiment, tapping and dragging an edge of the quadrangle may move two sides of the quadrangle simultaneously. For example, tapping and dragging a right bottom edge of the quadrangle moves the right and bottom sides while tapping and dragging a right top edge of the quadrangle moves the right and top sides. In one embodiment, tapping and dragging the aforementioned user controls may change a color at a point of impact. For example, tapping and dragging a right bottom edge of the quadrangle moves the right and bottom sides with the right bottom edge and the right and bottom sides of the quadrangle changing color. In one embodiment, tapping and dragging a side of the quadrangle proportionally moves two adjacent sides. For example, tapping and dragging a bottom side of the quadrangle proportionally moves the left and right sides. In one embodiment, the productivity application 30 may be configured to allow a user to tap and drag the side of the quadrangle in order to adjust the quadrangle when an edge of the quadrangle beyond an image boundary.

From operation 940, the routine 900 continues to operation 945, where the productivity application 30 executing on the computing device 10, may send a re-framed processed image to the productivity application 30 or the other applications 40, for multi-purpose sharing and archiving purposes. From operation 945, the routine 900 then ends.

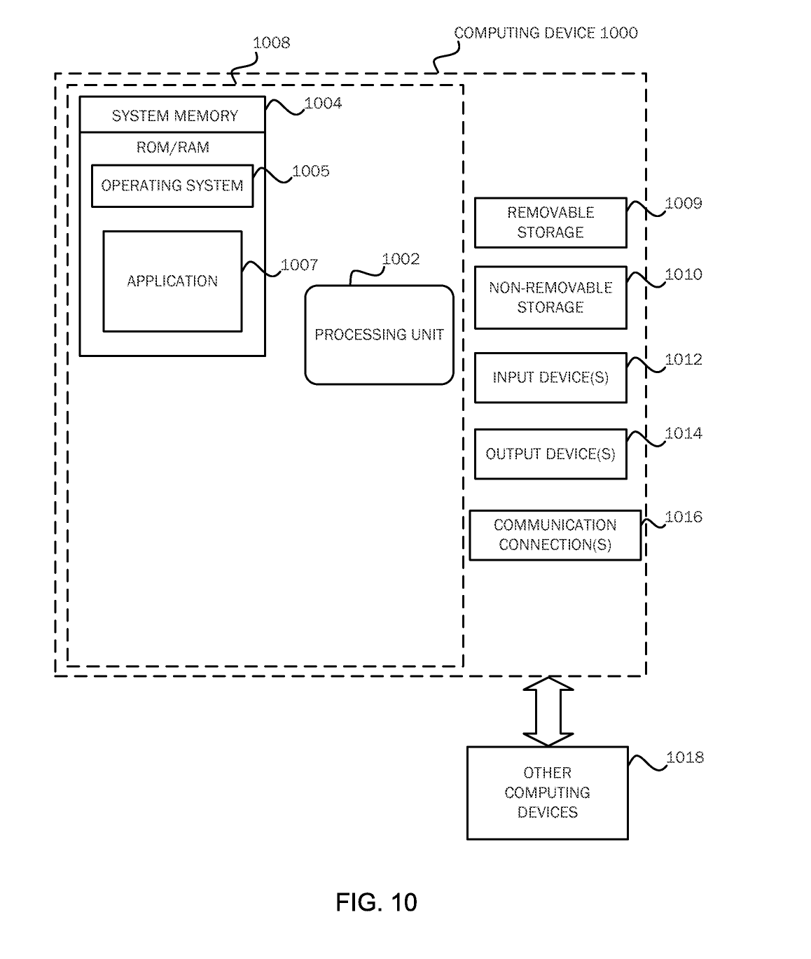

FIGS. 10-12 and the associated descriptions provide a discussion of a variety of operating environments in which embodiments of the invention may be practiced. However, the devices and systems illustrated and discussed with respect to FIGS. 10-12 are for purposes of example and illustration and are not limiting of a vast number of computing device configurations that may be utilized for practicing embodiments of the invention, described herein.

FIG. 10 is a block diagram illustrating example physical components of a computing device 1000 with which various embodiments may be practiced. In a basic configuration, the computing device 1000 may include at least one processing unit 1002 and a system memory 1004. Depending on the configuration and type of computing device, system memory 1004 may comprise, but is not limited to, volatile (e.g. random access memory (RAM)), non-volatile (e.g. read-only memory (ROM)), flash memory, or any combination. System memory 1004 may include an operating system 1005 and application 1007. Operating system 1005, for example, may be suitable for controlling the computing device 1000's operation and, in accordance with an embodiment, may comprise the WINDOWS operating systems from MICROSOFT CORPORATION of Redmond, Wash. The application 1007, for example, may comprise functionality for performing routines including, for example, processing and cropping images as described above with respect to the operations in routine 900 of FIG. 9.

The computing device 1000 may have additional features or functionality. For example, the computing device 1000 may also include additional data storage devices (removable and/or non-removable) such as, for example, magnetic disks, optical disks, solid state storage devices (“SSD”), flash memory or tape. Such additional storage is illustrated in FIG. 10 by a removable storage 1009 and a non-removable storage 1010. The computing device 1000 may also have input device(s) 1012 such as a keyboard, a mouse, a pen, a sound input device (e.g., a microphone), a touch input device for receiving gestures, an accelerometer or rotational sensor, etc. Output device(s) 1014 such as a display, speakers, a printer, etc. may also be included. The aforementioned devices are examples and others may be used. The computing device 1000 may include one or more communication connections 1016 allowing communications with other computing devices 1018. Examples of suitable communication connections 1016 include, but are not limited to, RF transmitter, receiver, and/or transceiver circuitry; universal serial bus (USB), parallel, and/or serial ports.

Furthermore, various embodiments may be practiced in an electrical circuit comprising discrete electronic elements, packaged or integrated electronic chips containing logic gates, a circuit utilizing a microprocessor, or on a single chip containing electronic elements or microprocessors. For example, various embodiments may be practiced via a system-on-a-chip (“SOC”) where each or many of the components illustrated in FIG. 10 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality, described herein may operate via application-specific logic integrated with other components of the computing device/system 1000 on the single integrated circuit (chip). Embodiments may also be practiced using other technologies capable of performing logical operations such as, for example, AND, OR, and NOT, including but not limited to mechanical, optical, fluidic, and quantum technologies. In addition, embodiments may be practiced within a general purpose computer or in any other circuits or systems.

The term computer readable media as used herein may include computer storage media. Computer storage media may include volatile and nonvolatile, removable and non-removable media implemented in any method or technology for storage of information, such as computer readable instructions, data structures, or program modules. The system memory 1004, the removable storage device 1009, and the non-removable storage device 1010 are all computer storage media examples (i.e., memory storage.) Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 1000. Any such computer storage media may be part of the computing device 1000. Computer storage media does not include a carrier wave or other propagated or modulated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

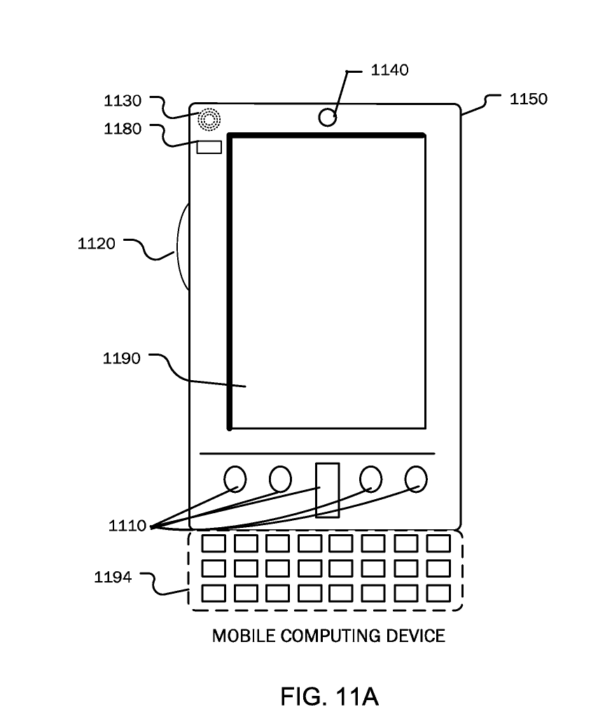

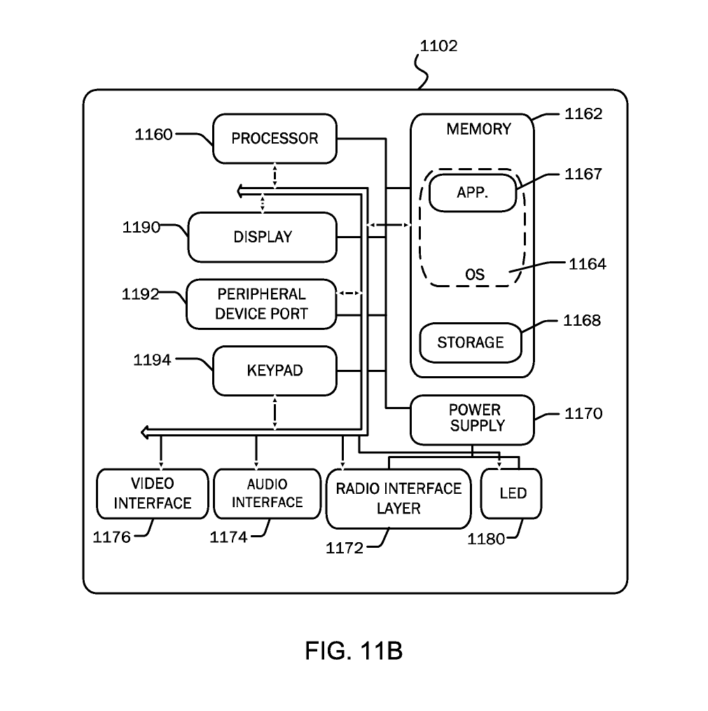

FIGS. 11A and 11B illustrate a suitable mobile computing environment, for example, a mobile computing device 1150 which may include, without limitation, a smartphone, a tablet personal computer, a laptop computer and the like, with which various embodiments may be practiced. With reference to FIG. 11A, an example mobile computing device 1150 for implementing the embodiments is illustrated. In a basic configuration, mobile computing device 1150 is a handheld computer having both input elements and output elements. Input elements may include touch screen display 1125 and input buttons 1110 that allow the user to enter information into mobile computing device 1150. Mobile computing device 1150 may also incorporate an optional side input element 1120 allowing further user input. Optional side input element 1120 may be a rotary switch, a button, or any other type of manual input element. In alternative embodiments, mobile computing device 1150 may incorporate more or less input elements. In yet another alternative embodiment, the mobile computing device is a portable telephone system, such as a cellular phone having display 1125 and input buttons 1110. Mobile computing device 1150 may also include an optional keypad 1105. Optional keypad 1105 may be a physical keypad or a “soft” keypad generated on the touch screen display.

Mobile computing device 1150 incorporates output elements, such as display 1125, which can display a graphical user interface (GUI). Other output elements include speaker 1130 and LED 1180. Additionally, mobile computing device 1150 may incorporate a vibration module (not shown), which causes mobile computing device 1150 to vibrate to notify the user of an event. In yet another embodiment, mobile computing device 1150 may incorporate a headphone jack (not shown) for providing another means of providing output signals.

Although described herein in combination with mobile computing device 1150, in alternative embodiments may be used in combination with any number of computer systems, such as in desktop environments, laptop or notebook computer systems, multiprocessor systems, micro-processor based or programmable consumer electronics, network PCs, mini computers, main frame computers and the like. Various embodiments may also be practiced in distributed computing environments where tasks are performed by remote processing devices that are linked through a communications network in a distributed computing environment; programs may be located in both local and remote memory storage devices. To summarize, any computer system having a plurality of environment sensors, a plurality of output elements to provide notifications to a user and a plurality of notification event types may incorporate the various embodiments described herein.

FIG. 11B is a block diagram illustrating components of a mobile computing device used in one embodiment, such as the mobile computing device 1150 shown in FIG. 11A. That is, mobile computing device 1150 can incorporate a system 1102 to implement some embodiments. For example, system 1102 can be used in implementing a “smartphone” that can run one or more applications similar to those of a desktop or notebook computer. In some embodiments, the system 1102 is integrated as a computing device, such as an integrated personal digital assistant (PDA) and wireless phone.

Application 1167 may be loaded into memory 1162 and run on or in association with an operating system 1164. The system 1102 also includes non-volatile storage 1168 within memory the 1162. Non-volatile storage 1168 may be used to store persistent information that should not be lost if system 1102 is powered down. The application 1167 may use and store information in the non-volatile storage 1168. The application 1167, for example, may comprise functionality for performing routines including, for example, processing and cropping images as described above with respect to the operations in routine 900 of FIG. 9.

A synchronization application (not shown) also resides on system 1102 and is programmed to interact with a corresponding synchronization application resident on a host computer to keep the information stored in the non-volatile storage 1168 synchronized with corresponding information stored at the host computer. As should be appreciated, other applications may also be loaded into the memory 1162 and run on the mobile computing device 1150.

The system 1102 has a power supply 1170, which may be implemented as one or more batteries. The power supply 1170 might further include an external power source, such as an AC adapter or a powered docking cradle that supplements or recharges the batteries.

The system 1102 may also include a radio 1172 (i.e., radio interface layer) that performs the function of transmitting and receiving radio frequency communications. The radio 1172 facilitates wireless connectivity between the system 1102 and the “outside world,” via a communications carrier or service provider. Transmissions to and from the radio 1172 are conducted under control of OS 1164. In other words, communications received by the radio 1172 may be disseminated to the application 1167 via OS 1164, and vice versa.

The radio 1172 allows the system 1102 to communicate with other computing devices, such as over a network. The radio 1172 is one example of communication media. The embodiment of the system 1102 is shown with two types of notification output devices: the LED 1180 that can be used to provide visual notifications and an audio interface 1174 that can be used with speaker 1130 to provide audio notifications. These devices may be directly coupled to the power supply 1170 so that when activated, they remain on for a duration dictated by the notification mechanism even though processor 1160 and other components might shut down for conserving battery power. The LED 1180 may be programmed to remain on indefinitely until the user takes action to indicate the powered-on status of the device. The audio interface 1174 is used to provide audible signals to and receive audible signals from the user. For example, in addition to being coupled to speaker 1130, the audio interface 1174 may also be coupled to a microphone (not shown) to receive audible (e.g., voice) input, such as to facilitate a telephone conversation. In accordance with embodiments, the microphone may also serve as an audio sensor to facilitate control of notifications. The system 1102 may further include a video interface 1176 that enables an operation of on-board camera 1140 to record still images, video streams, and the like.

A mobile computing device implementing the system 1102 may have additional features or functionality. For example, the device may also include additional data storage devices (removable and/or non-removable) such as, magnetic disks, optical disks, or tape. Such additional storage is illustrated in FIG. 11B by storage 1168.

Data/information generated or captured by the mobile computing device 1150 and stored via the system 1102 may be stored locally on the mobile computing device 1150, as described above, or the data may be stored on any number of storage media that may be accessed by the device via the radio 1172 or via a wired connection between the mobile computing device 1150 and a separate computing device associated with the mobile computing device 1150, for example, a server computer in a distributed computing network such as the Internet. As should be appreciated such data/information may be accessed via the mobile computing device 1150 via the radio 1172 or via a distributed computing network. Similarly, such data/information may be readily transferred between computing devices for storage and use according to well-known data/information transfer and storage means, including electronic mail and collaborative data/information sharing systems.

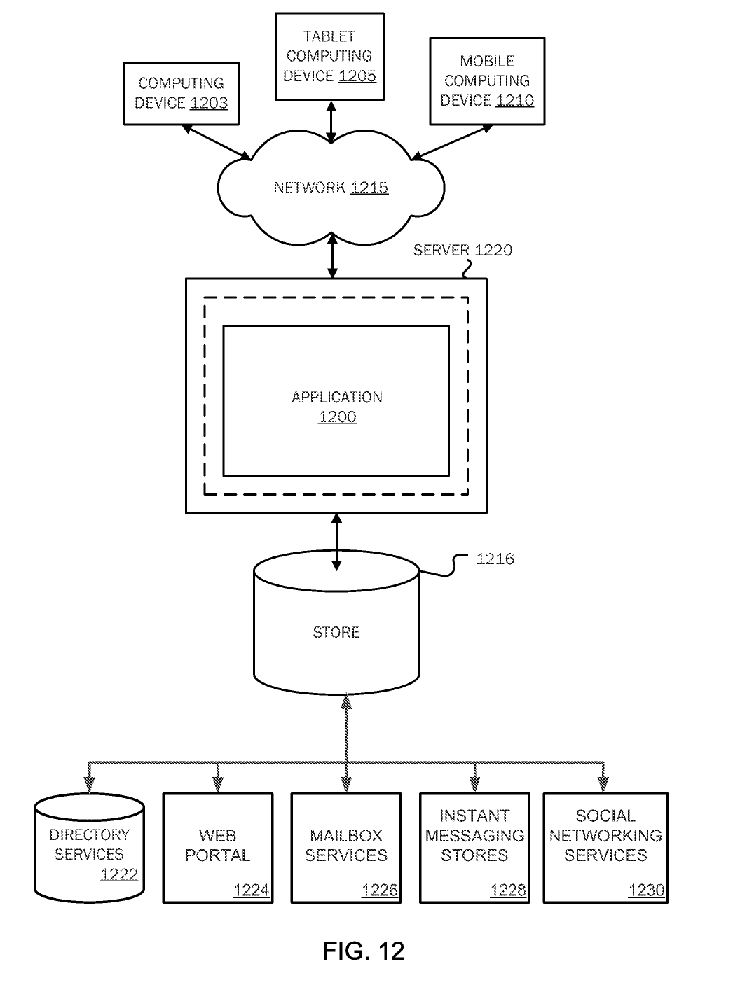

FIG. 12 is a simplified block diagram of a distributed computing system in which various embodiments may be practiced. The distributed computing system may include number of client devices such as a computing device 1203, a tablet computing device 1205 and a mobile computing device 1210. The client devices 1203, 1205 and 1210 may be in communication with a distributed computing network 1215 (e.g., the Internet). A server 1220 is in communication with the client devices 1203, 1205 and 1210 over the network 1215. The server 1220 may store application 1200 which may be perform routines including, for example, processing and cropping images as described above with respect to the operations in routine 900 of FIG. 9.

Content developed, interacted with, or edited in association with the application 1200 may be stored in different communication channels or other storage types. For example, various documents may be stored using a directory service 1222, a web portal 1224, a mailbox service 1226, an instant messaging store 1228, or a social networking site 1230.

The application 1200 may use any of these types of systems or the like for enabling data utilization, as described herein. The server 1220 may provide the application 1200 to clients. As one example, the server 1220 may be a web server providing the application 1200 over the web. The server 1220 may provide the application 1200 over the web to clients through the network 1215. By way of example, the computing device 10 may be implemented as the computing device 1203 and embodied in a personal computer, the tablet computing device 1205 and/or the mobile computing device 1210 (e.g., a smart phone). Any of these embodiments of the computing devices 1203, 1205 and 1210 may obtain content from the store 1216.

Various embodiments are described above with reference to block diagrams and/or operational illustrations of methods, systems, and computer program products. The functions/acts noted in the blocks may occur out of the order as shown in any flow diagram. For example, two blocks shown in succession may in fact be executed substantially concurrently or the blocks may sometimes be executed in the reverse order, depending upon the functionality/acts involved.

The description and illustration of one or more embodiments provided in this application are not intended to limit or restrict the scope of the invention as claimed in any way. The embodiments, examples, and details provided in this application are considered sufficient to convey possession and enable others to make and use the best mode of claimed invention. The claimed invention should not be construed as being limited to any embodiment, example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate embodiments falling within the spirit of the broader aspects of the general inventive concept embodied in this application that do not depart from the broader scope of the claimed invention.

What is claimed is:

1. A method comprising:
displaying, by the computing device, a menu comprising a plurality of image processing modes;
receiving, by the computing device, a selection of one of the plurality of image processing modes from the menu;
receiving, by a computing device, an image;
processing, by the computing device, the received image based on the selected one of the plurality of image processing modes;
displaying, by the computer device, a plurality of user controls overlaying the processed image;
receiving, by the computing device, a selection of one or more of the plurality of user controls to re-frame one or more boundaries of the processed image; and
sending, by the computing device, the re-framed processed image to a productivity application.

2. The method of claim 1, further comprising receiving another selection of the one of the plurality of image processing modes after receiving, by the computing device, the image.

3. The method of claim 1, further comprising receiving another image while processing, by the computing device, the received image based on the selected one of the plurality of image processing modes.

4. The method of claim 1, wherein receiving, by the computing device, a selection of one of the plurality of image processing modes from the menu comprises receiving a selection of a whiteboard processing mode from the menu.

5. The method of claim 1, wherein receiving, by the computing device, a selection of one of the plurality of image processing modes from the menu comprises receiving a selection of a document processing mode from the menu.

6. The method of claim 1, wherein receiving, by the computing device, a selection of one of the plurality of image processing modes from the menu comprises receiving one or more of a tap gesture and a swipe gesture to select the one of the plurality of image processing modes.

7. The method of claim 1, wherein receiving, by a computing device, an image comprises receiving the image from one or more of an image capture device and an image library.

8. The method of claim 1, wherein receiving, by a computing device, a selection of one or more of the plurality of user controls to re-frame one or more boundaries of the processed image comprises receiving a selection of at least one edge control for cropping a plurality of sides of a quadrangle framing the processed image.

9. The method of claim 1, wherein receiving, by a computing device, a selection of one or more of the plurality of user controls to re-frame one or more boundaries of the processed image comprises receiving a selection of at least one border control for cropping a plurality of sides of a quadrangle framing the processed image.

10. A computing device comprising:
a memory for storing executable program code; and
a processor, functionally coupled to the memory, the processor being responsive to computer-executable instructions contained in the program code and operative to:
display a menu comprising a plurality of image processing modes;
receive a user selection of one of the plurality of image processing modes from the menu;
receive an image from one or more of an image capture device and an image library;
process the received image based on the selected one of the plurality of image processing modes;
display a plurality of user controls overlaying the processed image;
receive a selection of one or more of the plurality of user controls to crop one or more boundaries of the processed image; and
send the cropped processed image to a productivity application.

11. The computing device of claim 10, wherein the processor is further operative to receive another user selection of the one of the plurality of image processing modes after receiving the image.

12. The computing device of claim 10, wherein the processor is further operative to receive another image while processing the received image based on the selected one of the plurality of image processing modes.

13. The computing device of claim 10, wherein the processor, in receiving a user selection of one of the plurality of image processing modes from the menu, is operative to receive a selection of one or more a whiteboard processing mode and a document processing mode from the menu.

14. The computing device of claim 10, wherein the processor, in receiving a user selection of one of the plurality of image processing modes from the menu, is operative to receive one or more of a tap gesture and a swipe gesture to select the one of the plurality of image processing modes.

15. The computing device of claim 10, wherein the processor, in receiving a selection of one or more of the plurality of user controls to crop one or more boundaries of the processed image, is operative to receive a selection of at least one edge control for cropping a plurality of sides of a quadrangle framing the processed image.

16. The computing device of claim 10, wherein the processor, in receiving a selection of one or more of the plurality of user controls to crop one or more boundaries of the processed image, is operative to receive a selection of at least one border control for cropping a plurality of sides of a quadrangle framing the processed image.

17. A computer-readable storage medium storing computer executable instructions which, when executed by a computer, will cause computer to perform a method comprising:
displaying a menu comprising a plurality of image processing modes;
receiving a selection of one of the plurality of image processing modes from the menu, the plurality of image processing modes comprising at least a whiteboard processing mode and a document processing mode;
receiving an image from one or more of an image capture device and an image library;
receiving another selection of the one of the plurality of image processing modes;
processing the received image based on the selected one of the plurality of image processing modes;
receiving another image while the received image based on the selected one of the plurality of image processing modes;
displaying a plurality of user controls overlaying the processed image;
receiving a selection of one or more of the plurality of user controls to re-frame one or more boundaries of the processed image; and
sending the re-framed processed image to a productivity application.

18. The computer-readable storage medium of claim 17, wherein receiving a selection of one of the plurality of image processing modes from the menu comprises receiving one or more of a tap gesture and a swipe gesture to select the one of the plurality of image processing modes.

19. The computer-readable storage medium of claim 17, wherein receiving a selection of one or more of the plurality of user controls to re-frame one or more boundaries of the processed image comprises receiving a selection of at least one edge control for cropping a plurality of sides of a quadrangle framing the processed image.

20. The computer-readable storage medium of claim 17, wherein receiving a selection of one or more of the plurality of user controls to re-frame one or more boundaries of the processed image comprises receiving a selection of at least one border control for cropping a plurality of sides of a quadrangle framing the processed image.
